(19) United States
(12) Patent Application Publication
(10) Pub. No.: US 2015/0258742 A1
(43) Pub. Date: Sep. 17, 2015

(54) PROCESS FOR MANUFACTURING A THERMOPLASTIC COMPOSITE PART IN A CLOSED MOULD, WITH INJECTION INTO A COLD MOULD

(71) Applicants: ARKEMA FRANCE, Colombes (FR); LE POLE DE PLASTURGIE DE L'EST, Saint Avold (FR)

(72) Inventors: Gilles Hochstetter, L'Hay Les Roses (FR); Jean-Pierre Cauchois, Obersteinbach (FR); Camille Perrin, Pontoy (FR); Henri Perrin, Brehain (FR); Michel Glotin, Saint-Cloud (FR)

(73) Assignees: LE POLE DE PLASTURGIE DE L'EST, Saint Avold (FR); ARKEMA FRANCE, Colombes (FR)

(21) Appl. No.: 14/437,759

(22) PCT Filed: Oct. 21, 2013
(86) PCT No.: PCT/FR2013/052510

§ 371 Date: Apr. 22, 2015

(30) Foreign Application Priority Data
Oct. 23, 2012 (FR) 1260096

(51) Int. Cl. B29C 70/48; B29C 43/02; B29C 67/24; B29C 35/00

(52) U.S. Cl. CPC B29C 70/48; B29C 35/00; B29C 43/02; B29C 67/24; B29K 2077/00

(57) ABSTRACT

A process for manufacturing a part made of thermoplastic composite material including a fibrous reinforcement and a matrix of thermoplastic polymer based on a thermoplastic polymer which impregnates said fibrous reinforcement, which process includes: a) a step of impregnating said dry fibrous reinforcement, by injection onto said reinforcement, of a precursor of said polymer, and moulding, with the polymerization step b) being simultaneous with the impregnating and moulding step and with the regulating temperature T2 for said mould being kept constant throughout the moulding cycle, and with reheating of the internal surface of the mould, just before said injection, using a heating means which is external to the mould and removable, with c) demoulding of the part, and d) optional continuation of the polymerization, if said polymerization is partial at demoulding, in a separate step outside the mould, by annealing in an oven at an annealing temperature.

The invention relates to a specific process for manufacturing in a closed mold, in particular via RTM, injection/compression molding or S-RIM, a part made of thermoplastic composite material based on a thermoplastic polymer, which is preferably semi-crystalline, and more particularly on a semi-crystalline polyamide having a high Tg with a reduced molding cycle and improved productivity.

The manufacturing of a part made of a thermoplastic composite based on a semi-crystalline polyamide by a molding technique in a closed mold, in particular by RTM, even using a composition which is a precursor of said polyamide based on reactive prepolymers which thus facilitates the impregnation of the fibrous reinforcement, does not prevent some specific additional problems which make this manufacturing more complicated, said problems having to be solved in order to improve the manufacturing cycle, and consequently the overall productivity of the molding. This is essentially linked to the fact that, for thermoplastic composites with high mechanical performance levels, high processing temperatures are required, in particular for injection in the molten state and molding in the closed mold. Given the need to cool the molded final part in order to allow it to be demolded and handled without risk of deformation during demolding and handling thereof, lengthy repeating heating-cooling cycles are required, and the productivity is affected by this; in addition, these cycles consume very high amounts of energy. This problem is even more specific in the case of thermoplastic polymers, the final matrix of which is semi-crystalline, in particular polyamide, with high melting temperatures which are often above 300° C. for the final polymer or for the semi-crystalline reactive prepolymers used as precursors, in particular comprising an aromatic and/or cycloaliphatic structure. This therefore means that much higher transformation temperatures are required, which necessitates heating and cooling thermal cycles of large amplitude and, consequently, management of these cycles which is more complicated and expensive in energy terms. This is even more problematic if it is designed to carry out this type of cycling rapidly. In point of fact, the cycle time is one of the predominant factors in the choice of molding solutions on an industrial basis.

The solution proposed by the present invention is a process for manufacturing a composite part in a closed mold and, in particular, a molding process of RTM (Resin Transfer Molding) type or by injection/compression or S-RIM (structural reaction injection molding) using a thermoplastic polymer as matrix of the composite, which is preferably semi-crystalline and more particularly semi-crystalline polyamide (PA), preferentially having a high Tg, i.e. of at least 90° C., in particular obtained from a reactive composition p) which is precursor of said polymer, based on reactive prepolymers, preferably semi-crystalline reactive prepolymers. This solution has the particularity of injecting the product (reactive precursor composition p)) at an injection temperature, T1, above the temperature T2 of the mold. According to this solution of the invention, T2 is the regulating temperature for the mold and it is kept constant throughout the molding cycle: in this sense, the molding process can be considered to be isothermal. More particularly, when the polymer constituting the matrix of the composite is amorphous, the regulating temperature T2 for the mold must be below the heat distortion temperature (HDT) of said composite material as measured according to standard ISO R 75 A. More preferentially, in the case where said polymer constituting the matrix of the composite is semi-crystalline, said regulating temperature T2 of the mold is below the crystallization temperature Tc of said polymer, even more preferentially it is between Tc and Tc −20° C. and even better still between Tc −5° C. and Tc −15° C.

Just before the injection of the reactive mixture into the mold, the internal wall of the mold is heated by an external and removable heating means to a temperature T3 of between T1 −40° C. and T1 +40° C. where T1 is the reactive mixture injection temperature. This heating means may be of the inductive or resistive type or of a type using infrared or microwaves: the device is therefore introduced into the open mold and then removed so as to allow the mold to be closed before the injection of the reactive mixture (reactive composition p). More preferentially, the heating may be carried out by injection of a hot gas fluid, such as hot air, into the mold before the injection of the reactive composition p) (or resin), the injection time typically being less than 10 s, the holding time in the mold being typically less than 30 s and its internal surface (wall) temperature T3 being between T1 −50° C. and T1 +50° C. Before the injection of the resin, said fluid, such as hot air, is driven from the mold by purging, for example, by placing said mold under vacuum by the optional presence of a vent or by leaving said mold ajar. Even more preferentially, use will be made, of nitrogen or another inert gas in place of air as gas fluid so as to avoid oxidizing the fibrous reinforcement which has been placed in the mold before the injection of the resin. In using hot nitrogen in place of hot air as hot (gas) fluid, it is also a question of avoiding degradation, by thermal oxidation, of the sizing of the reinforcing fibers. Rapidly after the injection, i.e. when the temperature T4 of the part in the mold is equal everywhere to said isothermal regulated temperature T2 of said mold, the composite part is demolded. If, at the time of the demolding, the polymerization of the matrix of the composite is not sufficient, it is continued in a separate annealing step in an oven. This operation can be carried out in parallel with respect to the part molding cycle and thus does not negatively affect the molding cycle time. The molding cycle is thus improved by the reduction in its duration, preferably with a cycle duration of less than (under) 10 min, preferably not exceeding 5 min and even more preferably of less than 2 min.

More particularly, the solution of the present invention remedying the cited drawbacks is therefore a specific process in a closed mold comprising impregnation of a dry fibrous reinforcement placed in said closed mold, by injection in the molten state of a reactive composition p) based on reactive semi-crystalline PA prepolymers, more particularly comprising an aromatic and/or cycloaliphatic structure, said composition being a precursor of said (matrix) thermoplastic polymer, and a step of at least partial and simultaneous polymerization, by polycondensation or polyaddition, with as specificity a temperature T2 for constant regulation or regulation under isothermal conditions of said mold, which is below the temperature T1 for injection of said reaction composition p), T1 being below the HDT of said composite, measured according to standard ISO R 75 A, and preferably above the HDT +100° C. if said matrix is amorphous, and T1 being above the melting temperature Tm of the polymer of the matrix is said polymer is semi-crystalline. More particularly, in the case of a semi-crystalline polymer, T2 is maintained at a value between Tc and Tc −20° C. where Tc is the crystallization temperature of this polymer. In an even more preferred version, T2 is between Tc −5° C. and Tc −15° C.

The first subject and principal subject of the present invention therefore relates to a process for manufacturing a part made of thermoplastic composite material comprising a fibrous reinforcement and a matrix of thermoplastic polymer, which is preferably semi-crystalline, more preferentially semi-crystalline polyamide, having a melting temperature Tm below 320° C., preferably below 300° C., and more preferentially below 280° C., more particularly between 200 and 280° C. In another preferred version, the polymer constituting the matrix of the composite may have a glass transition temperature Tg of at least 90° C., preferably of at least 100° C., more preferentially of at least 110° C., even more preferentially of at least 120° C. In an even more preferred version, the polymer constituting the matrix of the composite may be semi-crystalline and have a glass transition temperature Tg of at least 90° C., preferably of at least 100° C., more preferentially of at least 110° C., even more preferentially of at least 120° C.

Therefore, the first subject and principal subject of the invention relates to a process for manufacturing a part made of thermoplastic composite material comprising a fibrous reinforcement and a thermoplastic matrix constituting of a thermoplastic polymer, preferably a semi-crystalline thermoplastic polymer, more preferentially based on a semi-crystalline polyamide, and in particular having a melting temperature Tm below 320° C., preferably Tm below 300° C., more preferentially Tm below 280° C., said matrix impregnating said fibrous reinforcement, said process comprising:
a) a step of impregnating said dry fibrous reinforcement placed beforehand in said closed mold, by injection onto said reinforcement at an injection temperature T1 above the heat distortion temperature, HDT, of said composite material, measured according to standard ISO R 75 A, when its matrix consists of an amorphous polymer and T1 preferably being above the HDT +100° C., and in the case where the matrix of said composite consists of a semi-crystalline thermoplastic polymer, T1 being above the melting temperature Tm of said polymer, of a liquid reactive composition p), in the molten state, preferably having a viscosity at said injection temperature T1 less than 50 Pa·s, preferably less than 10 Pa·s, and more preferentially less than 5 Pa·s, said reactive composition p) being a precursor of said thermoplastic polymer, and being based on, or comprising, at least one reactive prepolymer of said thermoplastic polymer, with
   the regulating temperature T2 for said closed mold being maintained at a constant (isothermal) value during (all of) the molding, below said HDT of said composite material, when its matrix is amorphous, and when this matrix is semi-crystalline, said temperature T2 being between Tc and Tc −20° C., with Tc being the crystallization temperature of said matrix polymer, and preferably T2 being (maintained and) between Tc −5° C. and Tc −15° C.,
   the internal surface of said mold being heated just before the injection of said reactive composition p) into said mold at a temperature T3, between T1 −50° C. and T1 +50° C.,
      said heating of the internal surface (of said mold) being carried out just before the injection of said reactive composition p) via a heating means which is external to the mold and removable, and preferably,
      said external heating means using infrared or microwaves or being resistive or inductive and then being introduced into said mold in the open position, and then removed so as to allow the mold to be closed and said reactive composition p) to be injected,
   or (preferably) said external heating means being based on the blowing of a hot gas fluid, preferably of hot air, more preferentially of nitrogen or of another hot inert (non-oxidizing) gas fluid, into the mold in the closed position, in particular the temperature of said hot (gas) fluid being in particular between T1 −50° C. and T1 +50° C., and more particularly the injection time for said hot gas fluid being less than 30 s, preferably less than 10 s, and even more particularly with the time for maintaining said hot gas fluid in said mold being less than 1 minute, preferably less than 30 s, said mold then being purged of said hot gas fluid, before the introduction of said reactive composition p),
b) a step of at least partial polymerization of said reactive composition p) by polycondensation or by polyaddition as appropriate, and molding, with the polymerization step being simultaneous with the impregnating step a) and with said molding,
c) demolding of said part as soon as the temperature T4 of said part is equal to said temperature T2 for regulation using isothermal conditions of said mold, with the polymerization of said precursor composition p) being optionally partial,
d) optionally and if necessary, continuation of the polymerization of said part in a separate step outside the mold, by annealing in an oven, preferably at an annealing temperature Ta below the HDT of said material, for an amorphous (matrix) polymer and Ta being below the melting temperature Tm in the case of a semi-crystalline (matrix) polymer, and more particularly in the case of a semi-crystalline polymer, said temperature Ta being between Tm and Tm −30° C.

Said purging of said hot gas fluid, injected into said mold so as to allow said heating of the internal (wall) surface of said mold to said temperature T3, before injection of said reactive composition p), can be carried out, for example, by placing said mold under vacuum, followed by the injection under vacuum (mold maintained under vacuum) of said reactive composition p). It can also be carried out through a vent via the presence of such a vent in the mold or by leaving said mold ajar for a short period of time before reclosing and injecting said reactive composition.

Said reactive composition p) can be defined according to two options p1) and p2) as follows:
p1) a single-component precursor composition p11) or two-component precursor composition p12), said single-component composition p11) being based on a thermoplastic reactive prepolymer p11), which is preferably semi-crystalline and more preferentially a semi-crystalline polyamide reactive prepolymer, which is reactive with itself, preferably by polycondensation, and said two-component composition p12) being based on two thermoplastic reactive prepolymers p121) and p122), which are preferably semi-crystalline, more preferentially semi-crystalline polyamide reactive prepolymers, which are reactive with themselves, preferably by polycondensation or polyaddition,
p2) a two-component composition comprising a thermoplastic reactive prepolymer p21), which is preferably semi-crystalline, more preferentially a semi-crystalline polyamide reactive prepolymer, and a nonpolymeric chain extender p22) bearing groups which are reactive with those of said prepolymer p21), and with p21) and p22) being reactive by polyaddition reaction.

As examples of (amorphous and semi-crystalline) thermoplastic polymers suitable as thermoplastic matrix in the present invention, mention may be made of: polyamides, in particular comprising an aromatic and/or cycloaliphatic structure, including copolymers, for example polyamide/polyether copolymers, polyesters in particular comprising an aromatic and/or cycloaliphatic structure, polyaryl ether ketones (PAEKs), polyether ether ketones (PEEKs), polyether ketone ketones (PEKKs), polyether ketone ether ketone ketones (PEKEKKs), polyphenyl sulfides (PPSs), polyimides, in particular polyetherimides (PEIs) or polyamide-imides, polylsulfones (PSUs), in particular polyarylsulfones such as polyphenyl sulfones (PPSUs), polyethersulfones (PESs), PMMA, PVDF, and preferably polyamides and copolymers thereof, more particularly comprising an aromatic and/or semi-aromatic structure and which are preferably semi-crystalline.

As suitable examples of semi-crystalline thermoplastic polymers, mention may be made of polyamides (in particular comprising an aromatic and/or cycloaliphatic structure) and copolymers, polyesters (in particular comprising an aromatic and/or cycloaliphatic structure), polyaryl ether ketones (PAEKs), polyether ether ketones (PEEKs), polyether ketone ketones (PEKKs), polyether ketone ether ketone ketones (PEKEKKs), polyphenyl sulfides (PPSs) and PVDF.

More particularly preferably, the semi-crystalline polymers include polyamides and semi-crystalline copolymers thereof, in particular comprising an aromatic and/or cycloaliphatic structure. As amorphous thermoplastic polymers, mention may be made of poly(methyl) methacrylate (PMMA), polyetherimide (PEI), polysulfones (PSUs), polyaryl sulfones (PPSUs) and polyethersulfones (PESs).

More particularly, said process relates to a process for molding by RTM (resin transfer molding), injection/compression molding or S-RIM.

Said fibrous reinforcement is preferably based on long reinforcing fibers, preferably with a length-to-diameter aspect ratio or factor L/D of greater than 1000, preferably greater than 2000. They may be in the form of an assembly of fibers in the dry state. Said assembly may be a dry preform of fibers (before impregnation) placed in said closed mold.

More particularly, the polymerization in the mold may be only partial, with, in this case, a step, provided for and carried out separately, of finishing the molded part in a separate step of annealing outside the mold at an annealing temperature Ta below the HDT of said composite material measured according to standard ISO R 75 A, in the case where the matrix of said composite consists of an amorphous polymer or, in the case where the matrix of said composite consists of a semi-crystalline polymer, the annealing is carried out at a temperature Ta below the melting temperature Tm of said semi-crystalline thermoplastic polymer, and more particularly, in the preferred case of a semi-crystalline polymer, the annealing temperature Ta is between Tm and Tm −30° C.

Preferably, the difference between the injection temperature T1 and the internal surface (or wall) temperature T3 of said mold is less than 40° C. and preferably between 10 and 40° C.

In the case of a partial polymerization, during the demolding of step c), the overall degree of conversion of the reactive functions of said prepolymers in said reactive composition p), at the demolding of step c), is at least 50%, preferably at least 70% with a partial conversion, in particular not exceeding 90%.

The number-average molecular weight Mn (calculated from the titration of the end functions) of said reactive prepolymers, which are preferably semi-crystalline, in particular semi-crystalline polyamides, involved in said precursor composition, is in the range of from 500 to 10000, preferably from 1000 to 6000.

According to one preferred embodiment of the process of the invention, the viscosity of said precursor composition under the impregnation conditions, in particular under the impregnation temperature and time conditions, does not exceed 50 Pa·s, preferably does not exceed 10 Pa·s and more preferentially does not exceed 5 Pa·s. In the case of a semi-crystalline thermoplastic polymer, in particular a semi-crystalline polyamide making up the thermoplastic matrix of said composite according to the invention, it is preferentially characterized by a glass transition temperature Tg of at least 90° C., preferably of at least 100° C. and more preferentially of at least 110° C., and even more preferentially of at least 120° C., and a melting temperature Tm below 300° C., with Tm preferably being below 300° C., more preferentially below 280° C., more particularly between 200° C. and 280° C.

More particularly, said thermoplastic polymer of said matrix is semi-crystalline, preferably a semi-crystalline polyamide, said corresponding reactive prepolymers of the reactive composition p) also being semi-crystalline and said injection temperature T1 of step a) being higher than said melting temperature Tm of said thermoplastic polymer, preferably semi-crystalline polyamide.

The number-average molecular weight Mn of said final polyamide polymer of the thermoplastic matrix of said composite material is preferably in a range of from 10000 to 40000 and preferably from 12000 to 30000. Said final matrix polymer is obtained with corresponding reactive prepolymers (in said reactive composition p)) having a weight Mn which is at least two times lower than said Mn of said final polymer of the matrix of said composite.

In the preferred case of a semi-crystalline structure of said thermoplastic polymer of said matrix, in particular polyamide, it is essentially provided by the structure of the corresponding reactive prepolymers, as defined according to compositions p1) and p2) above, which are also semi-crystalline and involved in said precursor composition p).

Regarding said precursor composition p), according to a first preferred option, it can be defined according to p1) and in particular may be a single-component composition based on a bifunctional reactive polyamide prepolymer p11), which is preferably semi-crystalline, bearing on the same chain an amine end function and an acid (carboxy) end function.

According to another preferred option of said precursor composition p), it is defined according to p1), it is a two-component composition and is based on two prepolymers p12): a first bifunctional reactive polyamide prepolymer p121), which is preferably semi-crystalline, bearing two identical amine or acid (carboxy) reactive functions X′, and a second bifunctional reactive polyamide prepolymer p122), which is preferably semi-crystalline, bearing two identical amine or acid (carboxy) functions Y′, with the two functions X′ and Y′ being reactive with one another, more preferentially the two prepolymers p121) and 122) being semi-crystalline.

According to a second preferred option, said precursor composition is defined according to p2) and it is a two-component composition based on a bifunctional reactive polyamide prepolymer p21), which is preferably semi-crystalline, bearing two identical amine or acid (carboxy) reactive functions X and on a nonpolymeric chain extender, preferably having a molecular weight of less than 500 and in particular less than 400, said extender p22) bearing two identical reactive functions Y, with said function X of said prepolymer being reactive with said function Y of said extender. Said function Y of said extender p22) can be selected as follows as a function of X:
when X is carboxy, Y is chosen from: oxazoline, oxazine, imidazoline, aziridine or epoxy;
when X is amine, Y is chosen from: maleimide (preferably with a secondary amine in order to avoid crosslinking with bismaleimides), epoxy, blocked isocyanate, oxazinone, oxazolinone, caprolactam or carboxylic anhydride, and in the latter case in particular, said extender may be chosen from aromatic and/or cycloaliphatic cyclic anhydrides.

Examples of extenders p22) that are suitable for the invention are mentioned below. The part of the extender p22) bearing the two functions (groups) Y could be represented by a diradical -A′-, said extender p22) having an overall formula Y-A′-Y.

More particularly, when said extender Y-A′-Y corresponds to a function Y chosen from oxazinone, oxazolinone, oxazine, oxazoline or imidazoline, in this case, in the chain extender represented by Y-A′-Y, A′ can represent an alkylene, such as —(CH₂)ₘ— with m ranging from 1 to 14 and preferably from 2 to 10, or A′ can represent a cycloalkylene and/or an arylene which is substituted (alkyl) or unsubstituted, for instance benzenic arylenes, such as o-, m- or p-phenylenes, or naphthalenic arylenes, and preferably A′ may be an arylene and/or a cycloalkylene. This remains valid when Y is epoxy.

In the case of carbonyl- or terephthaloyl- or isophthaloyl-biscaprolactam as chain extender Y-A′-Y, the preferred conditions prevent the elimination of by-product, for instance caprolactam, during said polymerization and molding in the molten state.

In the case where Y is a blocked isocyanate function, this blocking can be obtained with blocking agents for the isocyanate function, for instance epsilon-caprolactam, methyl ethyl ketoxime, dimethylpyrazole or diethyl malonate.

Likewise, in the case where the extender is a dianhydride which reacts with a prepolymer p21) bearing X=amine, the preferred conditions prevent any formation of imide ring during the polymerization and molding (or processing) in the molten state.

For X=amine, the Y group is preferably chosen from: blocked isocyanate, oxazinone and oxazolinone or epoxy, more preferentially oxazinone and oxazolinone, with, as radical, A′ being as defined above.

As examples of chain extenders bearing oxazoline or oxazine reactive functions Y suitable for implementation of the invention, reference may be made to those described under references “A”, “B”, “C” and “D” on page 7 of application EP 0 581 642, and also to their preparation processes and their mode of reaction which are set out therein. “A” in said document is bisoxazoline, “B” is bisoxazine, “C” is 1,3-phenylenebisoxazoline and “D” is 1,4-phenylenebisoxazoline.

As examples of chain extenders with an imidazoline reactive function Y that are suitable for the implementation of the invention, reference may be made to those described (“A” to “F”) on pages 7 to 8 and table 1 of page 10, in application EP 0 739 924, and also to their preparation processes and their mode of reaction which are set out therein.

As examples of chain extenders with a reactive function Y=oxazinone or oxazolinone which are suitable for the implementation of the invention, reference may be made to those described under references “A” to “D” on pages 7 to 8 of application EP 0 581 641, and also to their preparation processes and modes of reaction which are set out therein.

As examples of suitable oxazinone (ring comprising six atoms) and oxazolinone (ring comprising five atoms) Y groups, mention may be made of the Y groups derived from: benzoxazinone, oxazinone or oxazolinone, it being possible for A′ to be a single covalent bond with respective corresponding extenders being: bis(benzoxazinone), bisoxazinone and bisoxazolinone.

A′ can also be a C₁ to C₁₄, preferably C₂ to C₁₀ alkylene, but A′ is preferably an arylene and more particularly it can be a phenylene (substituted with Y in positions 1,2 or 1,3 or 1,4) or a naphthalene radical (disubstituted with Y) or a phthaloyle (iso- or terephthaloyle) or A′ can be a cycloalkylene.

For the Y functions chosen from oxazine (6-membered ring), oxazoline (5-membered ring) and imidazoline (5-membered ring), the A′ radical may be as described above with it being possible for A′ to be a single covalent bond and with the respective corresponding extenders being: bisoxazine, bisoxazoline and bisimidazoline. A′ may also be a C₁ to C₁₄, preferably C₂ to C₁₀, alkylene. The A′ radical is preferably an arylene and, more particularly, it may be a phenylene (substituted with Y in positions 1,2 or 1,3 or 1,4) or a naphthalene radical (disubstituted with Y) or a phthaloyle (iso- or terephthaloyle), or A′ may be a cycloalkylene.

In the case where Y=aziridine (nitrogenous heterocycle comprising three atoms equivalent to ethylene oxide with the ether —O— being replaced with —NH—), the A′ radical may be a phthaloyle (1,1′-iso- or terephthaloyle) with, as example of extender of this type, 1,1′-isophthaloyl bis(2-methylaziridine).

The presence of a catalyst of the reaction between said prepolymer p21) and said extender p22) at a content ranging from 0.001% to 2%, preferably from 0.01% to 0.5%, relative to the total weight of two mentioned coreactants, can accelerate the (poly) addition reaction and thus shorten the production cycle. Such a catalyst can be chosen from: 4,4′-dimethylaminopyridine, p-toluenesulfonic acid, phosphoric acid, NaOH and optionally those described for a polycondensation or transesterification, as described in EP 0 425 341, page 9, lines 1 to 7.

According to a more specific case of the choice of said extender, A′ may represent an alkylene, such as —(CH₂)ₘ— with m ranging from 1 to 14 and preferably from 2 to 10, or represents an alkyl-substituted or unsubstituted arylene, such as benzenic arylenes (such as o-, m- or p-phenylenes) or naphthalenic arylenes (with arylenes: naphthylenes). Preferably, A′ represents a substituted or unsubstituted arylene which can be benzenic or naphthenic.

The fibers of the fibrous reinforcement may be continuous and present in the form of an assembly which may be a preform. They may be in the form of a unidirectional (UD) or multidirectional (2D, 3D) reinforcement. In particular, they may be in the form of wovens, fabrics, sheets, strips or plaits and can also be cut up, for example in the form of nonwovens (mats) or in the form of felts.

These reinforcing fibers can be chosen from:
mineral fibers, these having high melting temperatures Tm′ above the processing temperatures,
polymeric or polymer fibers, having a melting temperature Tm′ or, failing the Tm′, a glass transition temperature Tg′, much higher than the processing temperatures,
or mixtures of the abovementioned fibers.

More particularly, these reinforcing fibers can be chosen as follows:
the mineral fibers can be chosen from: carbon fibers, carbon nanotube fibers, glass fibers, in particular of E, R or S2 type, boron fibers, ceramic fibers, in particular silicon carbide fibers, boron carbide fibers, boron carbonitride fibers, silicon nitride fibers, boron nitride fibers, basalt fibers, fibers or filaments based on metals and/or alloys thereof, fibers based on metal oxides, such as Al₂O₃, metalized fibers, such as metalized glass fibers and metalized carbon fibers, or mixtures of the abovementioned fibers, and
the polymer or polymeric fibers, under the abovementioned condition, are chosen from:
   fibers of thermoplastic polymers, more particularly chosen from: polyethylene terephthalate (PET), polybutylene terephthalate (PBT),
   fibers of polyamides corresponding to one of the formulae: 6, 11, 12, 6.10, 6.12, 6.6, 4.6,
   fibers of aramids (such as Kevlar®) and aromatic polyamides, such as those corresponding to one of the formulae: PPD.T, MPD.I, PAA and PPA, with PPD and MPD being respectively p- and m-phenylenediamine, PAA being polyarylamides and PPA being polyphthalamides,
   fibers of block copolymers of polyamide, such as polyamide/polyether, or fibers of polyaryl ether ketones (PAEKs) such as polyether ether ketone (PEEK), polyether ketone ketone (PEKK) or polyether ketone ether ketone ketone (PEKEKK).

The preferred reinforcing fibers are long fibers chosen from: carbon fibers, including metalized carbon fibers, glass fibers, including metalized glass fibers of E, R or S2 type, fibers of aramids (such as Kevlar®) or of aromatic polyamides, fibers of polyaryl ether ketones (PAEKs), such as polyether ether ketone (PEEK), fibers of polyether ketone ketone (PEKK), fibers of polyether ketone ether ketone ketone (PEKEKK), or mixtures thereof.

The fibers more particularly preferred are chosen from: glass fibers, carbon fibers, ceramic fibers and aramid (such as Kevlar®) fibers, or mixtures thereof.

Said fibers can represent contents of 40% to 70% by volume and preferably of 50% to 65% by volume of said composite material.

The assembly of fibers can be random (mat), unidirectional (UD) or multidirectional (two-directional 2D, three-dimensional 3D, or the like). Its grammage, i.e. its weight per square meter, can range from 100 to 1000 g/m², preferably from 200 to 700 g/m².

Regarding the fibrous reinforcement of said thermoplastic composite material, it is preferably based on long reinforcing fibers with an L/D aspect ratio greater than 1000, preferably greater than 2000, L being the length and D being the diameter of the fiber.

The most preferred fibers are selected from glass fibers, carbon fibers, ceramic fibers and aramid fibers, or mixtures thereof.

In addition to said reinforcing fibers, the composition of said thermoplastic composite of the process according to the invention may comprise other fillers and additives.

Among the suitable fillers, mention may be made, for example, of: inorganic or organic fillers, such as carbon black, carbon nanotubes (CNTs), carbon nanofibrils, glass beads or powder, ground recycled polymers in the powder state.

Among the suitable additives, mention may be made of: additives which absorb in the UV or IR range so as to allow welding of the composite obtained, by laser (UV or IR) technology, and heat stabilizers chosen from antioxidants of sterically hindered phenol or sterically hindered amine type (HALS). The function of these stabilizers is to prevent thermal oxidation and sizeable photooxidation and degradation of the matrix polyamide of the composite obtained.

Said part made of thermoplastic composite material of the process of the invention is in particular a mechanical or structural part, including semi-structural, preferably 3D part. The present invention also covers the use of the process as defined according to the invention above, in the manufacture of mechanical or structural parts, which may be in 3D (three-dimensional), these parts being particularly used for applications in the following fields: the motor vehicle industry, the railroad industry, the marine industry, wind power, photovoltaics, the solar industry for thermal heating and power stations, sports, aeronautics and space, road transport (parts for trucks), the construction industry, civil engineering, urban equipment and signage, panels, and leisure.

General methods for determining the characteristics mentioned:
The melt viscosity of the prepolymer or of the precursor composition is measured according to the reference manual of the constructor of the measuring instrument used, which is a Physica MCR301 rheometer, under nitrogen flushing at the temperature given under a shear of 100 s⁻¹, between two parallel planes 50 mm in diameter.
The Mn of the thermoplastic polymer or prepolymer is determined from the titration (quantitative determination) of the end functions according to a potentiometric method (direct quantitative determination for NH₂ or carboxy) and from the theoretical functionality which is 2 (in end functions) for linear prepolymers and polymers prepared from only bifunctional monomers.
The glass transition temperature Tg of the thermoplastic polymers used is measured using a differential scanning calorimeter (DSC), after a 2nd heating pass, according to standard ISO 11357-2. The heating and cooling rate is 20° C./min.
The melting temperature Tm and the crystallization temperature Tc are measured by DSC, after a 1st heating, according to ISO 11357-3. The heating and cooling rate is 20° C./min.

The following examples are given by way of illustration of the invention and of its performance levels, without any limitation regarding the scope of the subjects claimed.

### EXAMPLES

### A) Preparation of Prepolymers P(X)n

### Example 1

### Semi-Crystalline Diacid Polyamide Prepolymer 11/6.T/10.T

The following are successively introduced into a two-liter autoclave reactor:

| | |
|---|---|
| 11-aminoundecanoic acid | 41.2 g |
| 1,6-hexanediamine (HMDA) | 71.3 g |
| 1,10-decanediamine | 250.3 g |
| Terephthalic acid | 390.0 g |
| Rhodorsil ® RG22 | 0.375 g |
| NaH₂PO₂, 60% in water | 3.0 g |
| water | 188.7 g |

The Rhodorsil® RG22, an antifoam, is sold by the company Bluestar Silicones.

After closing the reactor, the atmosphere is purged of its oxygen with nitrogen. The reactor (content) is subsequently heated to 250° C., the pressure in the reactor reaching 32 bar. The water is gradually removed from the reactor by expansion while maintaining 32 bar and an internal temperature of approximately 250° C. The pressure is then reduced to atmospheric pressure by expansion while gradually increasing the internal temperature to 300° C. The reactor having reached atmospheric pressure is then flushed with nitrogen for 20 minutes. The content of the reactor is then emptied out and cooled in water. After suction-filtering, coarse grinding and drying, 650 g of prepolymer are collected.

The essential properties and characteristics of this prepolymer are presented in table 1 below.

TABLE 1
Characteristics of the prepolymer of example 1

| | | | | | | | | | | Melt | T° vs |
|---|---|---|---|---|---|---|---|---|---|---|---|
| | | | | | | | | | Intrinsic | viscosity | melt |
| | | Tg | Tm | Tc | NH₂ | COOH | | Mn | viscosity | 100 s⁻¹ | viscosity |
| Prepolymer | X | (° C.) | (° C.) | (° C.) | (meq/g) | (meq/g) | n | calc | (dl/g) | (Pa · s) | (° C.) |
| 11/6T/10T | Carboxy | 101 | 267 | 235 | 0 | 0.845 | 2 | 2366 | 0.35 | 1.1 | 300 |

### B) Preparation of the Composite Parts and Performance Levels

Apparatus Used and Operating Principle

A piece of RTM equipment is used which comprises two separate heating chambers which make it possible to separately melt the prepolymer and the chain extender. Two pistons (one per chamber), operating under 1 to 10 bar, make it possible to convey the two molten components into a static mixer and then to inject the reactive mixture into a mold containing a fibrous reinforcement.

The residence time is short (less than 10 s) and makes it possible to prevent any significant chain extension. Thus, the viscosity of the mixture can be regarded as identical to those of the prepolymer alone, at the injection temperature.

The fibrous reinforcement used is a 600T FV fabric from Chomrat (600 g/m²). Four layers of this fibrous reinforcement were deposited in the mold before injection in order to manufacture a composite sheet. The content of fibers in the composite sheet is 60% by volume (vol %).

The speed of the piston also makes it possible to adjust the residence time in the mixer so as to compare the effect of certain parameters of the process according to the invention and outside the invention.

The molar ratio of reactive functions X of said prepolymer to reactive functions Y of said extender is: 1/1 (stoichiometry).

Mold: cylindrical, 70 mm×4 mm.
% by volume of fibers: 60 vol %.
Mechanical performance levels: 3-point bending according to standard ISO 14125.
Melting temperature Tm of the prepolymer and extender: 267° C.

### Examples of Composite

In all cases, use is made of the same reactive prepolymer (example 1 according to table 1) and, as chain extender, of PBO (bisoxazoline), Allinco 1-3 sold by the company DSM, which is a chain extender having two oxazoline functions.

### Example 1

### Comparative

Said prepolymer is melted in one of the chambers before chain extension. This prepolymer is diacid functionalized. In the other chamber, PBO is melted. The reactive mixture is then injected at 280° C. (T1) in less than 10 s into a mold maintained at 220° C. (T2). The melt viscosity of the mixture is the same as that of the prepolymer, i.e. 1 Pa·s.

Result: the impregnation is poor, the reactive mixture congeals and crystallizes on the wall of the cold mold and prevents fiber impregnation.

### Example 2

### According to the Invention Before Annealing and Completed with Annealing According to Example 3

Said prepolymer is melted in one of the chambers before chain extension. This prepolymer is diacid functionalized. In the other chamber, PBO (bisoxazoline), Allinco 1-3 sold by the company DSM, which is a chain extender having two oxazoline functions, is melted.

The reactive mixture is then injected at 280° C., in less than 10 s, into a mold maintained at 220° C. (T2). The melt viscosity of the mixture is the same as that of the prepolymer, i.e. 1 Pa·s. However, compared with the preceding example, just before the injection of the reactive mixture (prepolymer+extender), hot air is introduced at 260° C. in 10 s and maintained for a further 10 s, and then this hot air is purged under vacuum (50 mbar) in less than 10 s. Demolding is carried out at 220° C. and 5 minutes after the injection of the resin.

Results: the fiber impregnation is very good, the mechanical properties and the Tg are given in table 2 below. These properties show that the heating of the mold wall just before injection allows correct impregnation of the fibers and also demolding of the sheet at 220° C., even if the progression of the (partial) polymerization is not yet sufficient to make it possible to achieve the satisfactory final mechanical properties, but this can be achieved by means of an additional separate annealing step, as in example 3 below, which does not affect the molding cycle.

TABLE 2

| 3-POINT BENDING | | | DSC | |
|---|---|---|---|---|
| E | σ breaking | ε breaking | Tg | Tg composite |
| (GPa) | (MPa) | (%) | prepolymer | sheet |
| 13.0 | 160 | 2.16 | 101° C. | 105° C. |

### Example 3

### According to the Invention with Annealing

Said prepolymer is melted in one of the chambers before chain extension. This prepolymer is diacid functionalized. In the other chamber, PBO (bisoxazoline), Allinco 1-3 sold by the company DSM, which is a chain extender having two oxazoline functions, is melted.

The reactive mixture is then injected in less than 10 s and at 280° C. into a mold maintained at 220° C. The melt viscosity of the mixture is the same as that of the prepolymer, i.e. 1 Pa·s. Just before the injection of the reactive mixture, hot air is introduced at 260° C. in 10 s and maintained for a further 10 s, then this hot air is purged under vacuum in less than 10 s. Demolding is carried out at 220° C. and 5 minutes after the injection of the resin. Annealing of the composite sheet in an oven for 60 minutes at 250° C. is carried out.

Results: the fiber impregnation is very good (like example 2), the mechanical properties and the Tg are given in table 3 below. These properties are very good and show that heating the wall of the mold just before injection allows correct fiber impregnation, and demolding at 220° C., and also that the annealing in an oven after demolding allows polymerization that is sufficiently advanced to result in very satisfactory final mechanical properties.

TABLE 3

| 3-POINT BENDING | | | DSC | |
|---|---|---|---|---|
| E | σ breaking | ε breaking | Tg | Tg composite |
| (GPa) | (MPa) | (%) | prepolymer | sheet |
| 24.5 | 605 | 2.5 | 101° C. | 110° C. |

1. A process for manufacturing a part made of thermoplastic composite material comprising a fibrous reinforcement and a thermoplastic matrix consisting of a thermoplastic polymer, said matrix impregnating said fibrous reinforcement, wherein said process comprises:
a) a step of impregnating said dry fibrous reinforcement placed beforehand in said closed mold, by injection onto said reinforcement at an injection temperature T1 above the heat distortion temperature, HDT, of said composite material, measured according to standard ISO R 75 A, when its matrix consists of an amorphous polymer, and in the case where the matrix of the composite consists of a semi-crystalline thermoplastic polymer, T1 being above the melting temperature Tm of said polymer, of a liquid reactive composition p), in the molten state, said reactive composition p) being a precursor of said thermoplastic polymer, and being based on, or comprising, at least one reactive prepolymer of said thermoplastic polymer,
wherein the regulating temperature T2 for said closed mold is maintained at a constant (isothermal) value during the molding, below the HDT of said composite material, when its matrix is amorphous, and when this matrix is semi-crystalline, said temperature T2 is between Tc and Tc −20° C., with Tc being the crystallization temperature of said matrix polymer,
wherein the internal surface of said mold is heated just before the injection of said reactive composition p) into said mold, at a temperature T3 between T1 −50° C. and T1 +50° C.,
wherein said heating of the internal surface is carried out just before the injection of said reactive composition p), via a heating means which is external to the mold and removable,
b) a step of at least partial polymerization of said reactive composition p) by polycondensation or by polyaddition as appropriate, and molding, with the polymerization step being simultaneous with the impregnating step a) and with said molding,
c) demolding of said part as soon as the temperature T4 of said part is equal to said temperature T2 for regulation using isothermal conditions of said mold, with the polymerization of said precursor composition p) being optionally partial,
d) optionally and if necessary, continuation of the polymerization of said part in a separate step outside the mold, by annealing in an oven.

2. The process as claimed in claim 1, wherein said composition p) is defined according to the following options p1) and p2):
p1) a single-component precursor composition p11) or two-component precursor composition p12), said single-component composition p11) being based on a thermoplastic reactive prepolymer p11), which is reactive with itself, and said two-component composition p12) being based on two thermoplastic reactive prepolymers p121) and p122), which are reactive between them,
p2) a two-component composition comprising a thermoplastic reactive prepolymer p21), and a nonpolymeric chain extender p22) bearing groups which are reactive with those of said prepolymer p21), and with p21) and p22) being reactive by polyaddition reaction.

3. The process as claimed in claim 1, wherein it is an RTM (resin transfer molding) or injection/compression molding or S-RIM (Structural Reaction Injection Molding) process.

4. The process as claimed in claim 1, wherein said thermoplastic polymer of said matrix is semi-crystalline, as are said corresponding reactive prepolymers of the reactive composition p), with said injection temperature T1 of step a) being higher than said Tm of said thermoplastic polymer.

5. The process as claimed in claim 1, wherein said polymerization in the mold in step b) is only partial and wherein a step of finishing the molded part by annealing outside the mold is carried out separately at a temperature Ta below said HDT of said composite material, for an amorphous polymer, and at Ta below the melting temperature Tm of said thermoplastic polymer when it is semi-crystalline.

6. The process as claimed in claim 1, wherein the difference between the injection temperature T1 of said composition p) and the internal surface (or wall) temperature of said mold is less than 40° C.

7. The process as claimed in claim 1, wherein the overall degree of conversion of the reactive functions of said prepolymers in said reactive composition p), at the demolding step c) is at least 50%, with said conversion being only partial.

8. The process as claimed in claim 1, wherein the number-average molecular weight Mn (calculated from the quantitative determination of the functions) of said reactive prepolymers is in the range of from 500 to 10000.

9. The process as claimed in claim 1, wherein the viscosity of said precursor composition p) under the impregnation conditions does not exceed 50 Pa·s.

10. The process as claimed in claim 1, wherein the glass transition temperature of the polymer of said thermoplastic matrix is at least 90° C., and wherein the melting temperature Tm, in the case where said polymer is semi-crystalline is below 300° C.

11. The process as claimed in claim 1, wherein said precursor composition p) is as defined according to p1) while being a single-component composition based on a bifunctional reactive polyamide prepolymer p11) bearing on the same chain an amine end function and an acid (carboxy) end function.

12. The process as claimed in claim 1, wherein said precursor composition is as defined according to p1) while being a two-component composition based on two polyamide prepolymers p12): a first bifunctional reactive polyamide prepolymer p121) bearing two identical amine or acid (carboxy) reactive functions X′, and a second bifunctional reactive polyamide prepolymer p122) bearing two identical amine or acid (carboxy) functions Y′, with the two functions X′ and Y′ being reactive with one another semi crystalline.

13. The process as claimed in claim 1, wherein said precursor composition is as defined according to p2) while being a two-component composition comprising a bifunctional reactive polyamide prepolymer p21) bearing two identical amine or acid (carboxy) reactive functions X and a non-polymeric chain extender p22), said extender p22) bearing two identical reactive functions Y, with said functions X of said prepolymer p21) being reactive with said reactive functions Y of said extender p22).

14. The process as claimed in claim 13, wherein said function Y of said extender p22) is selected as follows according to X:
when X is carboxy, Y is chosen from: oxazoline, oxazine, imidazoline, aziridine or epoxy;
when X is amine, Y is chosen from: maleimide, epoxy, blocked isocyanate, oxazinone, oxazolinone, caprolactam or carboxylic anhydride (or carboxy).

15. The process as claimed in claim 1, wherein said fibrous reinforcement is based on long reinforcing fibers, in particular having an LID aspect ratio or factor of greater than 1000.

16. The process as claimed in claim 1, wherein said part is a mechanical or structural part, including semi-structural part.

17. Method of manufacture of mechanical and structural parts comprising a process as defined in claim 1 for applications in the following fields: the motor vehicle industry, the railroad industry, the marine industry, wind power, sports, aeronautics and space, photovoltaics, the solar industry including parts for thermal solar heating or solar power stations, road transport (parts for trucks), the construction field, civil engineering, urban equipment and signage, panels, and leisure.

18. A process as claimed in claim 1, wherein said thermoplastic polymer is a semi-crystalline polymer.

19. A process as claimed in claim 18, wherein said polymer is a semi-crystalline polyimide.

20. A process as claimed in claim 19, wherein said polymer has a Tm lower than 320° C.

21. A process as claimed in claim 20, wherein said polymer has a Tm lower than 300° C.

22. A process as claimed in claim 1, wherein the viscosity at the injection temperature T1 is lower than 10 Pa·s.

23. A process as claimed in claim 1, wherein said temperature T2 is between −5 and −15° C.

24. A process as claimed in claim 1, wherein said external heating means is using infrared or microwaves or is resistive or inductive and then is introduced into the mold in the open position, and then removed so as to allow the mold to be closed and said reactive composition p) to be injected, or said external heating means is based on the blowing of a hot gas fluid, into said mold in the closed position, the temperature of said hot gas fluid being between T1 −50° C. and T1 +50° C., said mold then being purged of said hot gas fluid, before the introduction of said reactive composition p).

25. A process as claimed in claim 1, wherein said annealing is held at a temperature Ta<HDT of said material for amorphous matrix and at Ta<Tm for a semi-crystalline matrix.

26. A process as claimed in claim 25, wherein in the case of semi-crystalline matrix, said temperature T2 is between Tm and Tm-30° C.

27. A process as claimed in claim 13, wherein said chain extender has a molecular weight lower than 500.
